(19) United States
(12) Patent Application Publication
(10) Pub. No.: US 2009/0091512 A1
(43) Pub. Date: Apr. 9, 2009

(54) DUAL DISPLAY DEVICE AND MULTI DISPLAY DEVICE USING THE SAME

(75) Inventors: Jun Su JUNG, Suwon-si (KR); Jeong Roh LEE, Suwon-si (KR); Jin Sung KIM, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/165,728

(22) Filed: Jul. 1, 2008

(30) Foreign Application Priority Data
Oct. 9, 2007 (KR) 2007-101225

(51) Int. Cl. G09G 5/00

(52) U.S. Cl. 345/1.1

(57) ABSTRACT

A dual display device in which the screen directions of two display panels, connected to each other, are variously changeable and a multi display device using the same. The dual display device includes a first display panel having a first screen, a second display panel having a second screen, and a connection shaft to connect the two display panels. The connection shaft includes a first shaft part rotatably coupled to the first display panel and a second shaft part rotatably coupled to the second display panel. The second shaft part extends from the first shaft part such that the second shaft part is perpendicular to the first shaft part.

### CROSS-REFERENCE TO RELATED APPLICATIONS

This application claims the benefit under 35 U.S.C. §119(a) of Korean Patent Application No. 2007-101225, filed on Oct. 9, 2007 in the Korean Intellectual Property Office, the disclosure of which is incorporated herein by reference in its entirety.

### BACKGROUND OF THE INVENTION

1. Field of the Invention

The present general inventive concept relates to a dual display device and a multi display device using the same, and, more particularly, to a dual display device constructed in a structure in which positions of two display panels, connected to each other, are freely changeable and a multi display device using the same.

2. Description of the Related Art

With the growth of information technology, portable electronic devices, such as personal digital assistants (PDA), mobile phones, and electronic books, can be used to surf the Internet and watch TV or movies in addition to their original functions. Recently, these devices have used two display panels to display various information on a relatively large screen.

Korean Patent Application Publication No. 2006 92621 (published on Aug. 23, 2006) discloses an electronic book terminal including two display panels connected to each other. The device is constructed in a structure in which the two display panels are connected to each other via a hinge such that the display panels are folded and unfolded. The device provides a relatively large screen to a user through the two display panels and allows the user to select and use any one of the two display panels.

In the above-described device, however, the two display panels are folded and unfolded only in one direction, with the result that it is not possible for a user to change the direction of the screen. Consequently, it is difficult to more effectively use contents, such as motion pictures, viewed through the composite screen.

### SUMMARY OF THE INVENTION

The present general inventive concept provides a dual display device in which the screen directions of two display panels, connected to each other, are freely changeable.

The present general inventive concept also provides a multi display device, using a dual display device in which the screen directions of two display panels are changeable, to accomplish various screen arrangements.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept can be achieved by providing a dual display device including a first display panel having a first screen, a second display panel having a second screen, and a connection shaft to connect the two display panels, wherein the connection shaft includes a first shaft part rotatably coupled to the first display panel and a second shaft part rotatably coupled to the second display panel, the second shaft part extending from the first shaft part such that the second shaft part is perpendicular to the first shaft part.

The connection shaft can connect a corner of the first display panel and a corner of the second display panel.

The dual display device may further include a first shaft receiving groove formed at the second display panel to receive a part of the first shaft part and a second shaft receiving groove formed at the first display panel to receive a part of the second shaft part.

The dual display device may further include at least one magnet mounted at the edges of the first and second display panels such that the first and second display panels can be attached to each other.

The dual display device may further include a first shaft connection member mounted to the first display panel for the connection of the first shaft part and a second shaft connection member mounted to the second display panel for the connection of the second shaft part.

The foregoing and/or other aspects and utilities of the present general inventive concept can also be achieved by providing a multi display device including a main display device and a sub display device mounted to the main display device, wherein the sub display device includes first and second sub display panels rotatably connected to each other via a connection shaft and at least one magnet mounted at the edges of the first and second sub display panels such that the first and second sub display panels can be mounted to or separated from the main display device, and the connection shaft includes a first shaft part rotatably coupled to the first sub display panel and a second shaft part rotatably coupled to the second sub display panel, the second shaft part extending from the first shaft part such that the second shaft part is perpendicular to the first shaft part.

The multi display device may further include at least one magnetic member mounted at the edge of the main display device such that the first and second display panels can be attached to the main display device.

The foregoing and/or other aspects and utilities of the present general inventive concept can also be achieved by providing a multi display device including a main display device, and a sub display device mounted to the main display device, the sub display device including first and second sub display panels rotatably connected to each other via a connection shaft and at least one fixing structure mounted at the edges of the first and second sub display panels such that the first and second sub display panels can be mounted to or separated from the main display device and the connection shaft including a first shaft part rotatably coupled to the first sub display panel and a second shaft part rotatably coupled to the second sub display panel, the second shaft part extending from the first shaft part such that the second shaft part is perpendicular to the first shaft part.

The foregoing and/or other aspects and utilities of the present general inventive concept can also be achieved by providing a display device including a first display panel, a second display panel proximal to the first display panel, a connection shaft rotatably connecting the first and second display panels to each other and at least one fixing structure disposed on or within one of the first or second display panels such that the first and second display panels can be reversibly, manually mounted to or separated from each other, as desired.

### BRIEF DESCRIPTION OF THE DRAWINGS

These and/or other aspects and utilities of the present general inventive concept will become apparent and more readily appreciated from the following description of the embodiments, taken in conjunction with the accompanying drawings, of which:

FIG. 1 is a perspective view illustrating a dual display device according to an embodiment of the present general inventive concept;

FIG. 2 is an exploded perspective view illustrating the connection shaft coupling structure of the dual display device according to the embodiment of FIG. 1;

FIGS. 3 to 5 are perspective views illustrating the use of the dual display device according to the embodiment of FIG. 1;

FIG. 6 is a sectional view taken along line VI-VI′ of FIG. 3;

FIGS. 7 to 10 are perspective views of a multi display device using the dual display device of FIG. 1 according to an embodiment of the present general inventive concept, illustrating various applications of the dual display device; and

FIG. 11 is a sectional view taken along line XI-XI′ of FIG. 7.

### DETAILED DESCRIPTION OF THE PREFERRED EMBODIMENTS

Reference will now be made in detail to the embodiment of the present general inventive concept, examples of which are illustrated in the accompanying drawings, wherein like reference numerals refer to like elements throughout. The embodiment is described below to explain the present general inventive concept by referring to the figures.

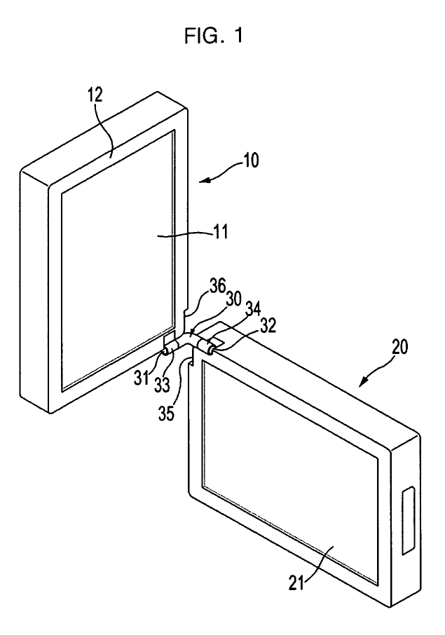

FIGS. 1 to 6 illustrate a dual display device according to an embodiment of the present general inventive concept. As illustrated in FIG. 1, the display device includes a first display panel 10 having a first screen 11, a second display panel 20 having a second screen 21, and a connection shaft 30 to connect the two display panels 10 and 20.

The first display panel 10 includes a display module to view an image through the first screen 11 and a case 12 covering the circumference and rear of the display module to protect the display module. The second display panel 20 has the same structure as the first display panel 10. The first and second display panels 10 and 20 are formed in the shape of a rectangle. That is, the length of the first and second display panels 10 and 20 is different from the width of the first and second display panels 10 and 20. Also, the first and second display panels 10 and 20 have the same size.

The first display panel 10 and the second display panel 20 may include a control unit (not shown) to realize an image, a storage unit (not shown) to store data, and a battery to supply power, mounted therein. Alternatively, the units may be mounted in one of the display panels, and the other display panel may be connected to the display panel having the units mounted therein via signal and power cables. Also, the first and second display panels 10 and 20 may be provided with a connection port (not shown) to which an external cable (not shown) to apply an image signal and power is connected, or may have a wireless transceiver (not shown) to receive an external signal or transmit an internal signal inside. The first and second display panels 10 and 20 may realize an image by the operation of the respective control units thereof or may realize the image of a signal received from the outside.

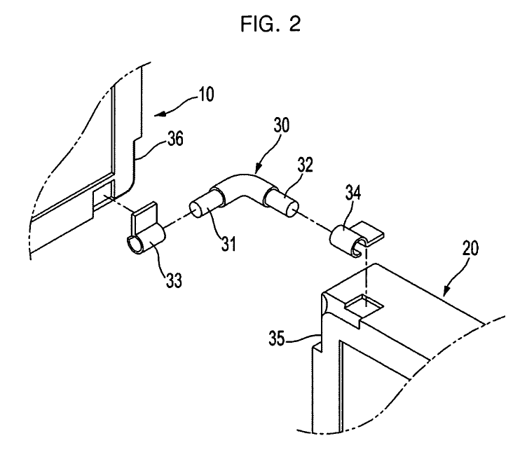

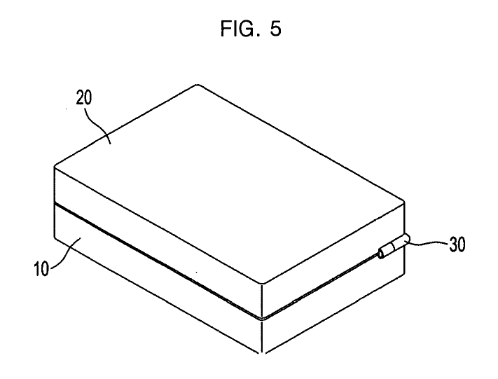

As illustrated in FIG. 2, the connection shaft 30, connecting the first display panel 10 and the second display panel 20, includes a first shaft part 31 rotatably coupled to a corner of the first display panel 10 and a second shaft part 32 rotatably coupled to a corner of the second display panel 20. The second shaft part 32 extends from the first shaft part 31 such that the second shaft part 32 is perpendicular to the first shaft part 31. That is, the connection shaft 30 is constructed in a structure in which the first shaft part 31 is connected to the second shaft part 32 in the shape of an “L.” For the coupling of the connection shaft 30, a first shaft connection member 33 to rotatably connect the first shaft part 31 is mounted to the first display panel 10, and a second shaft connection member 34 to rotatably connect the second shaft part 32 is mounted to the second display panel 20. Also, the second display panel 20 is provided with a first shaft receiving groove 35 to receive the first shaft part 31 and the first shaft connection member 33 when the first and second display panels 10 and 20 are folded as illustrated in FIG. 5. Similarly, the first display panel 10 is provided with a second shaft receiving groove 36 to receive the second shaft part 32 and the second shaft connection member 34 when the first and second display panels 10 and 20 are folded as illustrated in FIG. 5.

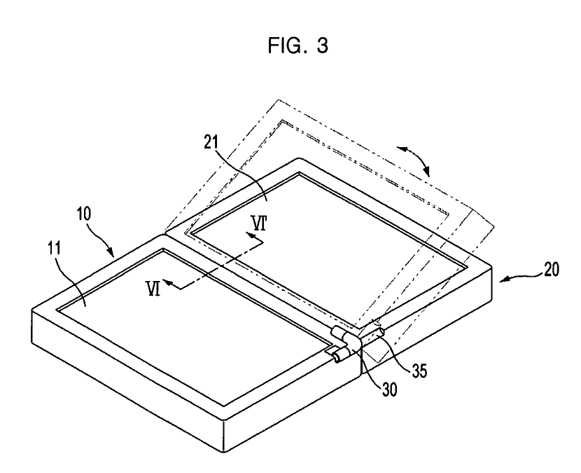

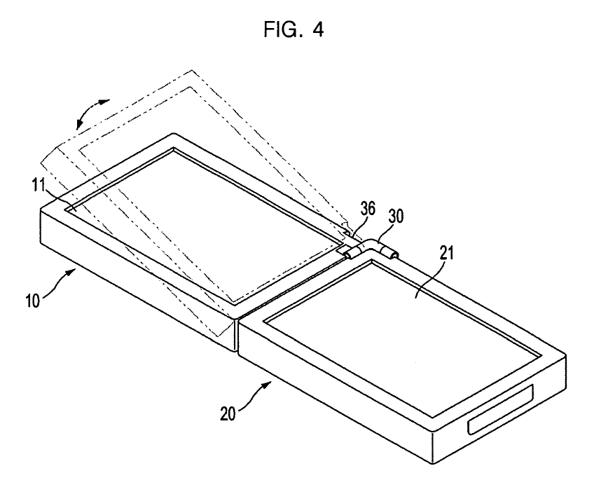

In the dual display device, the connection shaft 30, connecting the first display panel 10 and the second display panel 20, is formed in the shape of an “L,” therefore the degree of freedom at the connection is high. Consequently, it is possible to arrange the two display panels 10 and 20 such that long sides of the two display panels 10 and 20 are in contact with each other as shown in FIG. 3 or short sides of the two display panels 10 and 20 are in contact with each other as shown in FIG. 4. The dual display device according to the present general inventive concept has a high degree of freedom at the connection between the two display panels 10 and 20, and therefore, it is possible to easily change the screen arrangement such that the screen arrangement is suitable for contents provided through the two screens 11 and 12. Consequently, a user can more effectively use contents viewed through any particular screen.

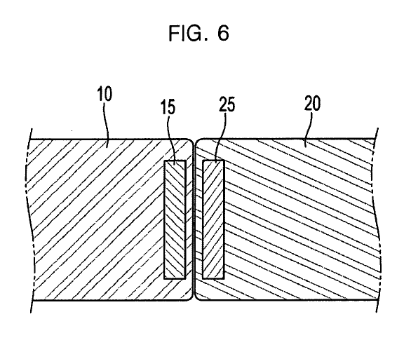

As illustrated in FIG. 6, magnets 15 and 25 are mounted in the edges of the first display panel 10 and the second display panel 20 such that the edges of the first display panel 10 and the second display panel 20 can be attached to each other by the magnets 15 and 25. The magnets 15 and 25 are successively mounted along the edges of the first and second display panels 10 and 20. Consequently, the edges of the first display panel 10 and the second display panel 20 are attached to each other, while the two display panels 10 and 20 are arranged as illustrated in FIG. 3 or 4, whereby the first display panel 10 and the second display panel 20 are prevented from shaking.

FIG. 5 illustrates that the first display panel 10 and the second display panel 20 are folded, such that the first display panel 10 and the second display panel 20 overlap each other, when not in use. Even in this case, a magnetic force of the magnets 15 and 25 mounted in the edges of the first display panel 10 and the second display panel 20 acts on the first display panel 10 and the second display panel 20, with the result that the first display panel 10 and the second display panel 20 remain attached to each other unless an external force is applied to the first display panel 10 and the second display panel 20. Consequently, it is possible to stably protect the screens 11 and 12 of the first display panel 10 and the second display panel 20.

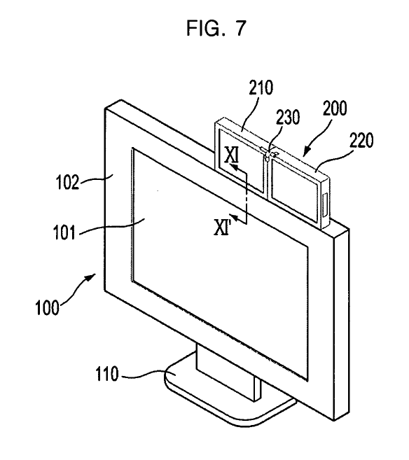

FIGS. 7 to 10 illustrate a multi display device using the dual display device with the above-stated construction, according to an embodiment of the present general inventive concept. As illustrated in FIG. 7, the multi display device includes a main display panel 100, a support unit 110 to support the main display panel 100, and a sub display device 200 mountable to or separable from the main display panel 100 as needed.

The main display panel 100 includes a display module to produce an image through a main screen 101, and a case 102 covering the circumference and rear of the display module to protect the display module.

The sub display device 200 includes a first sub display panel 210 and a second sub display panel 220 connected to the first sub display panel 210 via a connection shaft 230. The previously described dual display device may be used as the sub display device 200. Specifically, the first display panel 10 of the dual display device may serve as the first sub display panel 210, and the second display panel 20 of the dual display device may serve as the second sub display panel 220.

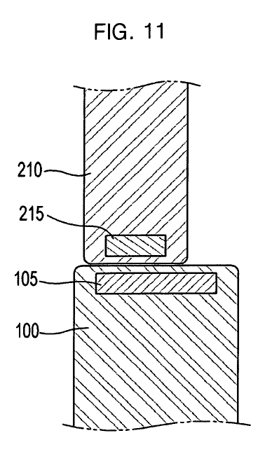

As illustrated in FIG. 11, magnetic members 105 are embedded in the edge of the main display panel 100 such that the first and second sub display panels 210 and 220 can be attached to the main display panel 100 by a magnetic force of magnets 215 embedded in the first and second sub display panels 210 and 220. The magnetic members 105 are successively mounted along the edge of the main display panel 100.

Alternatively, another fixing structure may be substituted for magnetic member 105 and/or magnets 215, including without limitation, such as a VELCRO member with a sticking patch, a hook with fixed eyelet, a hole for mating engagement with a cotter pin or various molded mating configurations. Preferably, the fixing structure will be designed to provide a degree of freedom during attachment as well as something comparable to the rotatable action exhibited by connection shaft 30 during use. Those skilled in the art will readily appreciate that any number of design solutions is possible in this context.

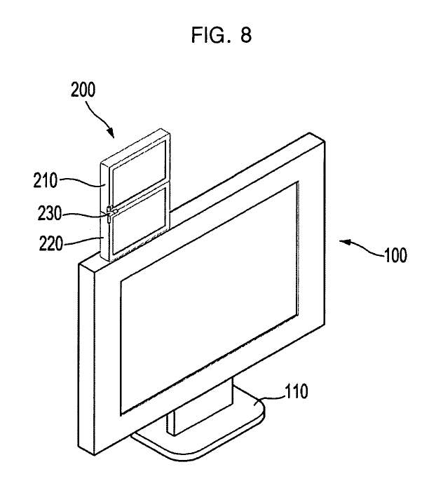

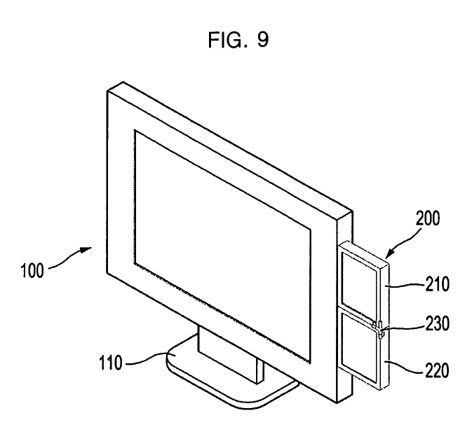

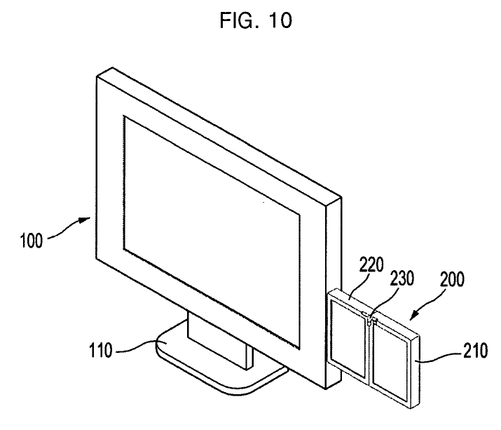

Consequently, it is possible for a user to attach the sub display device 200 to the top or side of the main display panel as needed, as shown in FIGS. 7 to 10. In addition, it is possible for the user to variously change the disposition of the first and second sub display panels 210 and 220, attached to the main display panel 100, as shown in FIGS. 7 to 10. As illustrated in FIG. 7, the two sub display panels 210 and 220 may be arranged in the longitudinal direction at the top of the main display panel 100. As illustrated in FIG. 8, the sub display panels 210 and 220 may be stacked vertically at the top of the main display panel 100. As shown in FIG. 9, the sub display panels 210 and 220 may be arranged vertically at the side of the main display panel 100. As shown in FIG. 10, the sub display panels 210 and 220 may be stacked horizontally at the side of the main display panel 100. When not in use, the sub display panels 210 and 220 may be attached to the top or side of the main display panel 100 while the sub display panels 210 and 220 are folded such that the sub display panels 210 and 220 overlap each other. These various coupling fashions are possible because the first and second sub display panels 210 and 220 are connected to each other via the “L”-shaped connection shaft exhibiting a high degree of freedom.

The first and second sub display panels 210 and 220 may be connected to the main display panel 100 or an additional power supply unit via an electric cable (not shown) such that the first and second sub display panels 210 and 220 are energized. Also, the first and second sub display panels 210 and 220 may be connected to the main display panel 100 or an additional image signal transmitter (not shown) via a signal cable (not shown). Of course, A wireless receiver (not shown) may be mounted in the first and second sub display panels 210 and 220 such that an image can be displayed on the first and second sub display panels 210 and 220 without the connection of a signal cable.

When the multi display device is used while the multi display device is connected to a computer, it is possible for a user to perform Internet surfing or word processing on the main display panel 100 while a messenger, a dictionary, or an image, such as an electronic album, is displayed on the first and second sub display panels 210 and 220, whereby user's convenience is improved.

As apparent from the above description, the dual display device according to embodiments of the present general inventive concept is constructed such that the first display panel and the second display panel are connected to each other via the connection shaft exhibiting a high degree of freedom. Consequently, the present general inventive concept has the effect of variously changing the screen directions of the first and second display panels.

Also, the dual display device according to embodiments of the present general inventive concept is constructed such that the edges of the first display panel and the second display panel are attached to each other. Consequently, the present general inventive concept has the effect of preventing the two display panels from being spaced apart from each other or shaking after the adjustment of the screen directions of the first and second display panels.

Also, the multi display device according to the present general inventive concept is constructed such that the first sub display panel and the second sub display panel, attached to the main display device, are connected to each other via the connection shaft exhibiting a high degree of freedom. Consequently, the present general inventive concept has the effect of variously changing the screen disposition.

Furthermore, the multi display device according to embodiments of the present general inventive concept is constructed such that the first sub display panel and the second sub display panel can be attached to the main display panel by magnets. Consequently, the present general inventive concept has the effect of easily mounting or separating the first sub display panel and the second sub display panel to or from the main display panel.

Although a few embodiments of the present general inventive concept have been shown and described, it would be appreciated by those skilled in the art that changes may be made in this embodiment without departing from the principles and spirit of the general inventive concept, the scope of which is defined in the claims and their equivalents.

What is claimed is:

1. A dual display device comprising:
a first display panel having a first screen;
a second display panel having a second screen; and
a connection shaft to connect the two display panels, wherein
the connection shaft includes a first shaft part rotatably coupled to the first display panel and a second shaft part rotatably coupled to the second display panel, the second shaft part extending from the first shaft part such that the second shaft part is perpendicular to the first shaft part.

2. The dual display device according to claim 1, wherein the connection shaft connects a corner of the first display panel and a corner of the second display panel.

3. The dual display device according to claim 1, further comprising:
a first shaft receiving groove formed at the second display panel to receive a part of the first shaft part; and
a second shaft receiving groove formed at the first display panel to receive a part of the second shaft part.

4. The dual display device according to claim 1, further comprising:
at least one magnet mounted at the edges of the first and second display panels such that the first and second display panels can be attached to each other.

5. The dual display device according to claim 1, further comprising:
a first shaft connection member mounted to the first display panel for the connection of the first shaft part; and
a second shaft connection member mounted to the second display panel for the connection of the second shaft part.

6. A multi display device comprising:
a main display device; and
a sub display device mounted to the main display device, wherein
the sub display device includes first and second sub display panels rotatably connected to each other via a connection shaft and at least one magnet mounted at the edges of the first and second sub display panels such that the first and second sub display panels can be mounted to or separated from the main display device, and
the connection shaft includes a first shaft part rotatably coupled to the first sub display panel and a second shaft part rotatably coupled to the second sub display panel, the second shaft part extending from the first shaft part such that the second shaft part is perpendicular to the first shaft part.

7. The multi display device according to claim 6, wherein the connection shaft connects a corner of the first sub display panel and a corner of the second sub display panel.

8. The multi display device according to claim 6, further comprising:
a first shaft receiving groove formed at the second sub display panel to receive a part of the first shaft part; and
a second shaft receiving groove formed at the first sub display panel to receive a part of the second shaft part.

9. The multi display device according to claim 6, further comprising:
at least one magnetic member mounted at the edge of the main display device such that the first and second display panels can be attached to the main display device.

10. A multi display device comprising:
a main display device; and
a sub display device mounted to the main display device, the sub display device including first and second sub display panels rotatably connected to each other via a connection shaft and at least one fixing structure disposed at the edges of the first and second sub display panels such that the first and second sub display panels can be mounted to or separated from the main display device, the connection shaft including:
a first shaft part rotatably coupled to the first sub display panel, and
a second shaft part rotatably coupled to the second sub display panel, the second shaft part extending from the first shaft part such that the second shaft part is perpendicular to the first shaft part.

11. The multi display device according to claim 10, wherein the connection shaft connects a corner of the first sub display panel and a corner of the second sub display panel.

12. The multi display device according to claim 10, further comprising:
a first shaft receiving groove formed at the second sub display panel to receive a part of the first shaft part; and
a second shaft receiving groove formed at the first sub display panel to receive a part of the second shaft part.

13. A display device comprising:
a first display panel;
a second display panel proximal to the first display panel;
a connection shaft rotatably connecting the first and second display panels to each other; and
at least one fixing structure disposed on or within one of the first or second display panels such that the first and second display panels can be reversibly, manually mounted to or separated from each other, as desired.

14. The multi display device of claim 13, wherein the fixing structure includes a magnet.

15. The multi display device of claim 13, wherein the fixing structure includes an embedded magnet in each panel.
